(19) United States
(12) Patent Application Publication
(10) Pub. No.: US 2015/0365765 A1
(43) Pub. Date: Dec. 17, 2015

(54) STEREO AUDIO INPUT APPARATUS

(71) Applicant: ELECTRONICS AND TELECOMMUNICATIONS RESEARCH INSTITUTE, Daejeon (KR)

(72) Inventor: Jae Guk GWON, Daejeon (KR)

(21) Appl. No.: 14/619,254

(22) Filed: Feb. 11, 2015

(30) Foreign Application Priority Data
Jun. 12, 2014 (KR) 10-2014-0071563

(51) Int. Cl. H04R 5/033

(52) U.S. Cl. CPC H04R 5/033

(57) ABSTRACT

Provided herein is a stereo audio input apparatus including a first microphone configured to have a shape that is insertable into a user's ear, and to convert audio being received into a first electric signal; a second microphone configured to have a shape that is insertable into a user's ear, and to convert audio being received into a second signal; and a signal processing unit configured to process the first signal and second signal being output from the first microphone and second microphone.

### CROSS-REFERENCE TO RELATED APPLICATION

The present application claims priority to Korean patent application number 10-2014-0071563, filed on Jun. 12, 2014, the entire disclosure of which is incorporated herein in its entirety by reference.

### BACKGROUND

1. Field of Invention

Various embodiments of the present invention relate to an audio apparatus, and more particularly, to a stereo audio input apparatus.

2. Description of Related Art

A human body has two ears one on each side of its head, and thus the distance from an audio source may be different between the two ears, causing a time difference for sound to arrive at each ear. This time difference causes a phase difference in the sound that the two ears accept, which enables the human body to determine the precise direction of the audio source. This auditory effect is called the binaural effect. Since a human's ears are attached on both sides of the head, they are influenced by the diffraction effect of sound. Thus, microphones were developed to have the same structure as the head of a human body and thus having the same effects as the ears of the human body. This microphone is called a dummy head microphone.

### SUMMARY

A purpose of various embodiments of the present invention is to provide a stereo audio input apparatus that is capable of making similar effects as a dummy head microphone, even without a dummy head microphone.

According to an embodiment of the present invention, there is provided a stereo audio input apparatus including a first microphone configured to have a shape that is insertable into a user's ear, and to convert audio being received into a first electric signal; a second microphone configured to have a shape that is insertable into a user's ear, and to convert audio being received into a second signal; and a signal processing unit configured to process the first signal and second signal being output from the first microphone and second microphone.

Herein, the first microphone and second microphone may each have a shape of an earphone.

Herein, the first microphone may include an earphone housing configured to have a shape that is insertable into a user's ear; and an audio sensing unit configured to sense the audio being received and generate the first electric signal, wherein the earphone housing may be configured to have an externally-directed opening, and the audio sensing unit may be configured inside the opening to sense the audio coming in from outside.

Herein, the second microphone may include an earphone housing configured to have a shape that is insertable into a user's ear; and an audio sensing unit configured to sense the audio being received and generate the second electric signal, wherein the earphone housing may be configured to have an externally-directed opening, and the audio sensing unit may be configured inside the opening to sense the audio coming in from outside.

Herein, the stereo audio input apparatus may further include a first attach member configured to accommodate the first microphone and be attached to an external object; and a second attach member configured to accommodate the second microphone and be attached to an external object.

Herein, the first attach member and the second attach member may each have a shape of an outer ear.

Herein, the first attach member and the second attach member may be configured to be attached to a dummy head.

Herein, the first microphone may be accommodated such that it is detachable from the first attach member.

According to the aforementioned embodiments of the present invention, even without using a dummy head microphone, similar binaural effects of a dummy head microphone may be obtained.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 illustrates a microphone of a stereo audio input apparatus according to an embodiment of the present invention inserted into an ear of a human body;

FIGS. 2A and 2B are detailed illustrations of a microphone of a stereo audio input apparatus according to an embodiment of the present invention;

FIG. 3 is a view of a human being wearing a stereo audio input apparatus according to an embodiment of the present invention;

FIG. 4 is a view for explaining how a microphone is accommodated in an attach member and is operated according to an embodiment of the present invention; and

FIG. 5 is a block diagram of a configuration of a stereo audio input apparatus an embodiment of the present invention.

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘a first’ and ‘a second’ may be used to describe various components, but they should not be construed as limited to those various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

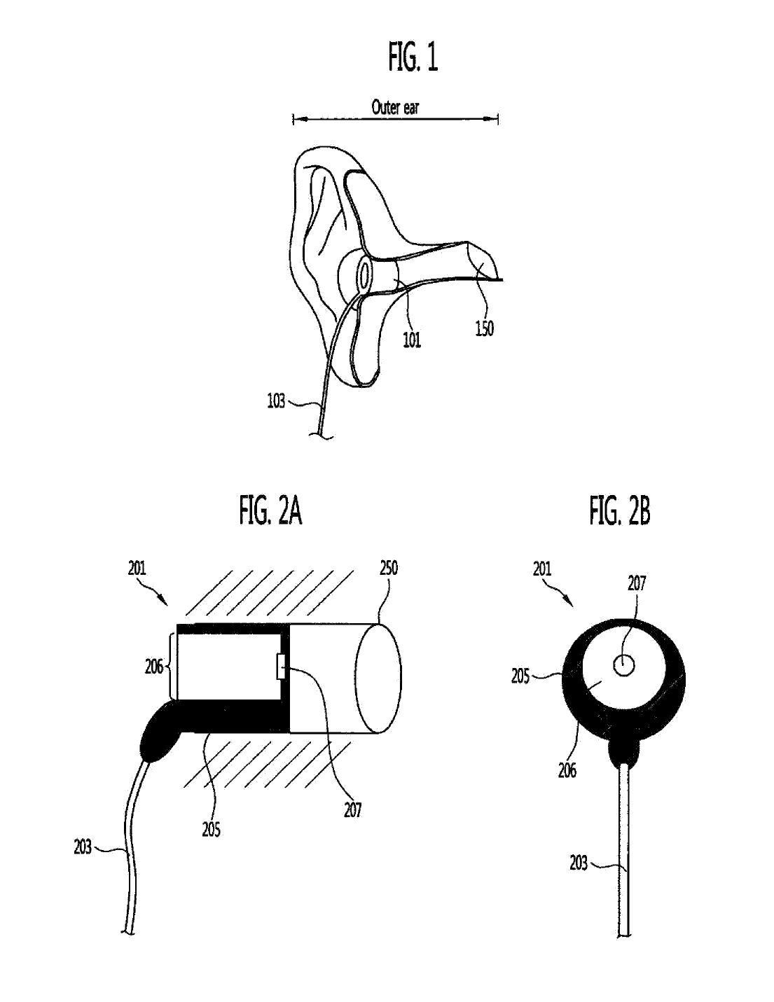

FIG. 1 illustrates a microphone of a stereo audio input apparatus according to an embodiment of the present invention 101 inserted into an ear of a human body.

FIG. 1 illustrates an outer ear of a human body. For convenience of explanation, illustrations on parts irrelevant to the present invention have been omitted. The microphone of a stereo audio input apparatus according to an embodiment of the present invention 101 has a similar shape as an earphone. FIG. 1 illustrates one microphone, but a stereo audio input apparatus according to an embodiment of the present invention includes two microphones, each mounted to each ear of a user to receive audio. FIG. 1 illustrates a microphone 101 mounted to the right ear of the user. An eardrum 150 is located inside an outer ear meatus of the user illustrated in FIG. 1.

Comparing when a human actually senses audio with when a microphone of a stereo audio input apparatus according to an embodiment of the present invention senses audio, when a human actually hears sound, the sound that is collected near an earflap flows inside the outer ear meatus and is sensed by a vibration of the eardrum 150, whereas in the case of a stereo audio input apparatus according to an embodiment of the present invention, sound that flows inside the earflap is sensed in the microphone that the user is wearing and is converted into electric signals. Electric signals output from the microphone 101 are sent to a signal processing unit (not illustrated) through a connecting line 103. In an embodiment, the electric signals output from the microphone 101 may be sent to the signal processing unit (not illustrated) through a wireless channel. In such a case, the microphone 101 may send the electric signals to the signal processing unit through wireless signals without a connecting line.

As illustrated in FIG. 1, a microphone 101 of a stereo audio input apparatus according to an embodiment of the present invention may be embodied as an earphone and be inserted into a user's ear, and accordingly, as audio is sensed in a location actually close to the eardrum, it is possible to obtain audio effects similar to when a human actually hears sound. Only one microphone is illustrated in FIG. 1, but a stereo audio input apparatus according to an embodiment of the present invention includes two microphones, each mounted to each ear of a user to receive audio, and thus effects such as the diffraction effect of sound and direction awareness caused by time difference of sensing audio may both be reflected in an audio input signal. Therefore, even without a dummy head microphone, similar effects may be obtained. With a stereo audio input apparatus according to an embodiment of the present invention, it is possible to obtain the binaural effects by inserting a microphone into a user's eat

FIGS. 2A and 2B are detailed views of a microphone of a stereo audio input apparatus according to an embodiment of the present invention.

Referring to FIGS. 2A and 2B, the microphone 201 includes an earphone housing 205 and an audio sensing unit 207. The earphone housing 205 may have a shape of an earphone that is insertable into a user's ear. The audio sensing unit 207 senses audio being received from near the user's ear and generates an electric signal. Furthermore, the earphone housing 205 may have an externally-directed opening 206, and the audio sensing unit 207 may be provided inside the opening 206 to sense audio flowing from outside into the opening. The audio sensing unit 207 may convert the sensed audio into an electric signal and send the electric signal to a signal processing unit (not illustrated) through a connecting line 203.

FIG. 2A mimetically illustrates a microphone 201 inserted into a user's ear. As aforementioned, as a microphone 201 of a stereo audio input apparatus according to an embodiment of the present invention may be inserted into an outer ear meatus, and the audio sensing unit 207 of the microphone 201 may be located near the eardrum 250 of the user inside the outer ear meatus 250 to sense audio being received from near the user's ear, the diffraction effect of sound and direction awareness caused by the time difference of audio may all be inflected in an audio input signal. Therefore, even without using a dummy head microphone, similar effects may be obtained. With a stereo audio input apparatus according to an embodiment of the present invention, it is possible to obtain the binaural effects by inserting a microphone into a user's ear.

However, the embodiment illustrated in FIGS. 2A and 2B are only for exemplary purpose. A microphone of a stereo audio input apparatus may be embodied in various shapes to be inserted into a user's ear.

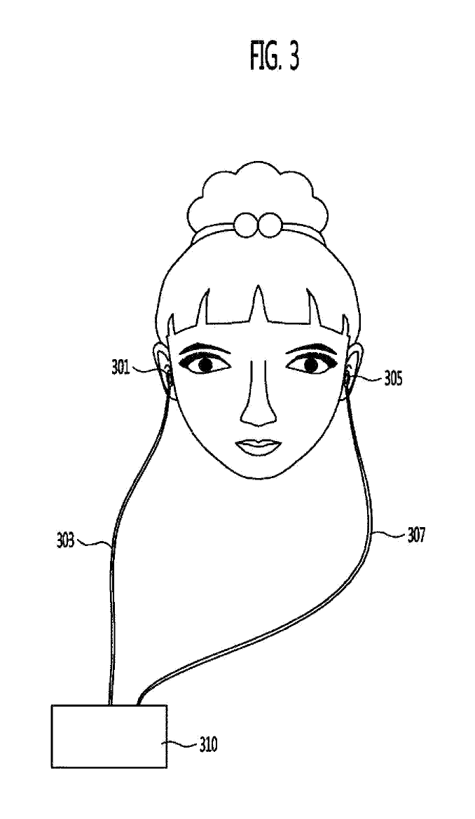

FIG. 3 is a view illustrating a user wearing a stereo audio input apparatus according to an embodiment of the present invention.

Referring to FIG. 3, a stereo audio input apparatus that a user is wearing includes a first microphone 301, second microphone 305, and signal processing unit 310. As illustrated in FIG. 3, the first microphone 301 and second microphone 305 are connected to the signal processing unit 310 through a first connecting line 303, and a second connecting line 307, respectively. The first microphone 301 has a shape that is insertable into a user's ear, and converts audio being received near a right ear of the user into a first electric signal. The converted first electric signal is sent to the signal processing unit 310 through the first connecting line 303. The second microphone 305 has a shape that is insertable into a user's ear, and converts audio being received near a left ear of the user into a second electric signal. The converted second electric signal is sent to the signal processing unit 310 through the second connecting line 307.

The signal processing unit 310 processes the first electric signal and second electric signal output from the first microphone 301 and second microphone 305, respectively. The signal processing unit 310 may process the first electric signal and second electric signal in various ways. For example, the signal processing unit 310 may receive the first electric signal and second electric signal, and may perform at least one of removing noise, generating stereophonic sound, generating virtual sound field effect, filtering and correcting sound quality. The signal processing unit 310 may receive and process the first electric signal and second electric signal, and then store the processed first and second electric signal in an internal storage apparatus, or send the processed first and second electric signal to another apparatus.

In FIG. 3, the first microphone 301 and second microphone 305 are connected to the signal processing unit 310 through the first connecting line 303 and second connecting line 307, respectively, but the first microphone 301 and second microphone 305 may be configured to send the first electric signal and second electric signal to the signal processing unit 310 as wireless signals through a wireless channel.

As illustrated in FIG. 3, according to a stereo sound input apparatus of an embodiment of the present invention, it is possible to obtain the binaural effects by inserting a microphone having a shape of an earphone into a user's ear. Therefore, even without using a bulky dummy head microphone, similar effects may be obtained.

Furthermore, the user wearing microphones of a stereo audio input apparatus may obtain more varied and vivid audio effects by intentionally moving the head to suit the necessary occasions or changing directions.

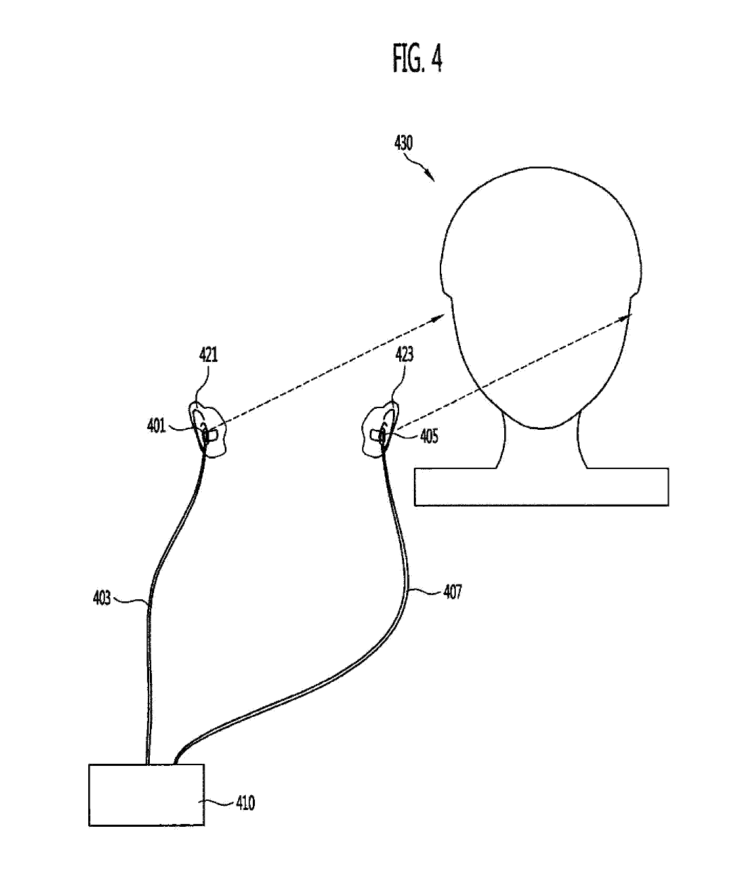

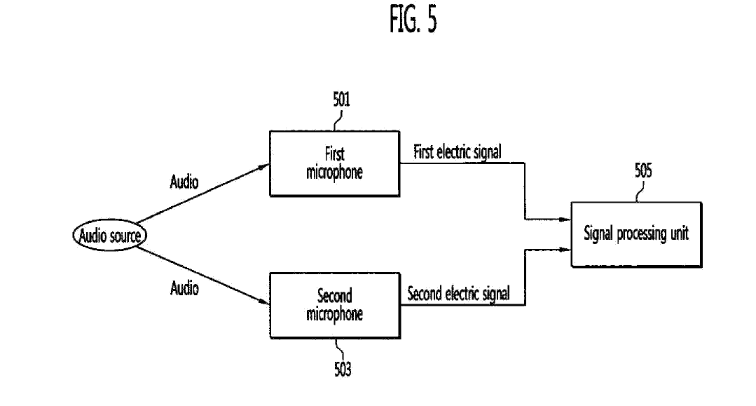

FIG. 4 is a view for explaining how a microphone is accommodated into an attach member and is operated according to an embodiment of the present invention.

Referring to FIG. 4, a stereo audio input apparatus according to an embodiment of the present invention includes a first microphone 401, second microphone 405, and signal processing unit 410. As illustrated in FIG. 4, the first microphone 401 and the second microphone 405 are connected to the signal processing unit 410 through a first connecting line 403, and second connecting line 407, respectively. The first microphone 401 has a shape that is insertable into a user's ear, and converts sound being received near a user's right ear into a first electric signal. The converted first electric signal is sent to the signal processing unit 410 through the first connecting line 403. The second microphone 405 has a shape that is insertable into a user's ear, and converts sound being received near the user's left ear into a second electric signal. The converted second electric signal is sent to the signal processing unit 410 through the second connecting line 407. The signal processing unit 410 processes the first electric signal and second electric signal output from the first microphone 4101 and second microphone 405, respectively. The processing of the first electric signal and second electric signal by the signal processing unit 410 was aforementioned with reference to FIG. 3, and thus repeated explanation is omitted.

Furthermore, in FIG. 4, the first microphone 401 and second microphone 405 are connected to the signal processing unit 410 through the first connecting line 403 and second connecting line 407, respectively, but the first microphone 401 and second microphone 405 may be configured to send the first electric signal and second electric signal to the signal processing unit 410 as wireless signals through a wireless channel.

Referring to FIG. 4, a stereo audio input apparatus according to an embodiment of the present invention may further include a first attach member 421 and second attach member 423. The first attach member 421 may accommodate the first microphone 401 and be attached to a dummy head 430. The second attach member 423 may accommodate the second microphone 403 and be attached to the dummy head 430. The first attach member 421 and second attach member 423 may be attached to the dummy head 430 in various ways. For example, in an embodiment, the first attach member 421 and second attach member 423 may be attached to the dummy head 430 by an adhesive means such as a tape. In another embodiment, the first attach member 421 and second attach member 423 may be attached to the dummy head 430 by a magnetic material such as a magnet.

A user may use the first attach member 421 and second attach member 423 when attaching a first microphone 401 and second microphone 403 to an object such as a dummy head 430 to receive audio instead of wearing it. In such a case, the first attach member 421 and second attach member 423 may have shapes similar to a human's right outer ear and left outer ear, respectively. For example, the first attach member 421 and second attach member 423 may be fabricated to have shapes similar to a human's earflap, so as to obtain similar sound receiving effects near a humans' outer ear as when a human actually hears sound, all the more enabling sound inputting similar to actual sound inputting. Furthermore, when the user does not directly use a first microphone 401 and second microphone 403, the user may use the first attach member 421 and second attach member 423 thereby attach the first microphone 401 and second microphone 403 in a fixed manner and receive sound. Furthermore, the user may attach the first microphone 401 and second microphone 403 to one of various external objects other than the dummy head m a fixed manner when necessary through the first attach member 421 and second attach member 423.

FIG. 5 is a block diagram illustrating a configuration of a stereo audio input apparatus according to an embodiment of the present invention.

Referring to FIG. 5, a stereo audio input apparatus according to an embodiment of the present invention includes a first microphone 501, second microphone 503, and signal processing unit 505. The first microphone 501 has a shape that is insertable into a user's ear, and converts audio being received into a first electric signal. The second microphone 503 has a shape that is insertable into a user's ear, and converts audio being received into a second electric signal. The audio being transmitted from a sound source to the first microphone 501 and to the second microphone 503 are different from each other, and thus the first electric signal and second electric signal may be different signals. A signal processing unit 505 processes the first and second electric signal being output from the first microphone 501 and second microphone 503. A stereo audio input apparatus according to the present embodiment of the present invention includes the first microphone 501 and second microphone 503, each mounted to each ear of a user to receive audio, and thus the diffraction effect of sound and the effect of direction awareness caused by time difference of sensing audio may all be reflected in an audio input signal. Therefore, even without using a dummy head microphone, similar effects may be obtained. Thus, it is possible to obtain the binaural effects by inserting a microphone into a user's ear.

The terms ‘˜unit’ used in the present invention may mean a software component or a hardware component such as an FPGA and ASIC, and ‘˜unit’ performs certain roles. However, ‘˜unit’ should not be construed as limited to software or hardware. ‘˜unit’ may be configured to be included in a storage medium to be addressed, or may be configured to reproduce one or more processing units. Therefore, for example, ‘˜unit’ includes components such as software components, object-oriented software components, class components, and task components, and processes, functions, properties, procedures, subroutines, segments of program codes, drivers, firmware, microcodes, circuits, data, databases, data structures, tables, arrays and parameters. The components and functions provided in the ‘˜unit’ may be combined with more components and ‘˜unit’, or may be divided into further components and ‘˜unit’. Not only that, the components and ‘˜unit’ may be embodied to reproduce one or more CPUs.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A stereo audio input apparatus comprising
a first microphone configured to have a shape that is insertable into a user's ear, and to convert audio being received into a first electric signal;
a second microphone configured to have a shape that is insertable into a user's ear, and to convert audio being received into a second signal; and
a signal processing unit configured to process the first signal and second signal being output from the first microphone and second microphone.

2. The apparatus according to claim 1,
wherein the first microphone and second microphone each has a shape of an earphone.

3. The apparatus according to claim 2,
wherein the first microphone comprises:
an earphone housing configured to have a shape that is insertable into a user's ear; and
an audio sensing unit configured to sense the audio being received and generate the first electric signal,
wherein the earphone housing is configured to have an externally-directed opening, and the audio sensing unit is configured inside the opening to sense the audio coming in from outside.

4. The apparatus according to claim 2,
wherein the second microphone comprises:
an earphone housing configured to have a shape that is insertable into a user's ear; and
an audio sensing unit configured to sense the audio being received and generate the second electric signal,
wherein the earphone housing is configured to have an externally-directed opening, and the audio sensing unit is configured inside the opening to sense the audio coming in from outside.

5. The apparatus according to claim 2,
further comprising a first attach member configured to accommodate the first microphone and be attached to an external object; and
a second attach member configured to accommodate the second microphone and be attached to an external object.

6. The apparatus according to claim 5,
wherein the first attach member and the second attach member each has a shape of an outer ear.

7. The apparatus according to claim 5,
wherein the first attach member and the second attach member are configured to be attached to a dummy head.

8. The apparatus according to claim 5,
wherein the first microphone is accommodated such that it is detachable from the first attach member.
